(19) United States
(12) Patent Application Publication
(10) Pub. No.: US 2020/0354503 A1
(43) Pub. Date: Nov. 12, 2020

(54) THIOURETHANE BASED AEROGELS

(71) Applicants: Henkel AG & Co. KGaA, Duesseldorf (DE); Henkel IP & Holding GmbH, Duesseldorf (DE)

(72) Inventors: Izaskun Miguel Garcia, Alicante (ES); Belen del Saz-Orozco Rodriguez, Las Rozas de Madrid (ES); Ilaria de Santo, Naples (IT); Asta Sakalyte, Sant Salvador Tarragona (ES); Elizabeth Torres Cano, Barcelona (ES); Fouad Salhi, Farmington, CT (US)

(21) Appl. No.: 16/937,636

(22) Filed: Jul. 24, 2020

Related U.S. Application Data
(63) Continuation of application No. PCT/EP2018/084948, filed on Dec. 14, 2018.

(30) Foreign Application Priority Data
Jan. 25, 2018 (EP) 18382042.2

(51) Int. Cl. C08G 18/09; B01J 13/00; C08J 9/28; C08G 18/20; C08G 18/18

(52) U.S. Cl. CPC C08G 18/092; B01J 13/0091; C08J 9/28; C08G 2101/0091; C08G 18/1866; C08G 18/2063; C08J 2205/026; C08G 18/2072

(57) ABSTRACT

The present invention relates to a thiourethane based aerogels obtained by reacting an isocyanate compound having a functionality equal to or greater than 2 and a thiol compound having a functionality equal to or greater than 2 in the presence of a solvent. Aerogels according to the present invention are generally hydrophobic, high performance materials. Aerogels according to the present invention are light weight they have low thermal conductivity, low shrinkage and high mechanical properties.

### TECHNICAL FIELD OF THE INVENTION

The present invention relates to a thiourethane based aerogels obtained by reacting an isocyanate compound having a functionality equal to or greater than 2 and a thiol compound having a functionality equal to or greater than 2 in the presence of a solvent. Aerogels according to the present invention are generally hydrophobic, high performance materials.

### BACKGROUND OF THE INVENTION

Thermal insulation is highly important in many applications such as construction, transport and industry among many others to save energy and reduce costs. Depending on the application, space limitations would envisage thin insulating layers. In these cases, the thermal conductivity of the material needs to be extremely low to get good insulating performance from thin insulating layer. Additionally, in some applications, in addition to good insulation properties, high mechanical properties are required. Furthermore, in some applications hydrophobicity and resistance to water and moisture are also needed.

Current thermal insulating materials are made mostly from polyurethane (PU) foams. PU foams have closed cell structure that contain a gas (blowing agent), which has a lower thermal conductivity than the air. Over time, the gas diffuses, and is replaced by air, increasing the thermal conductivity of the foams, and therefore, decreasing the foam's insulating performance.

Aerogels are light-weight materials with a low thermal conductivity compared to common thermal insulators in the market. Thus, thickness of the insulating layer can be reduced while obtaining similar insulating performance.

Aerogels differ from conventional PU foams in their structure. Aerogels have open-cell structures and do not contain any blowing agents, but air. Aerogels are low-density and three-dimensional assemblies of nanofibres and/or nanoparticles derived from drying wet-gels by exchanging the pore-filling solvent to a gas usually with a supercritical fluid. By these means, the capillary forces exerted by the solvent due to evaporation are minimized, and structures with large internal void space are achieved. Aerogels' morphology itself is responsible for their low thermal conductivity. Aerogels' narrow pore size induces the reduction of air thermal conductivity. The high porosity of these materials is responsible for their very low thermal conductivities, which makes aerogels extremely attractive materials for thermal insulating applications.

Generally, aerogels are prepared through sol-gel processes. The combination of a crosslinked structure together with the formation of supramolecular interactions within it (mainly hydrogen bonding) leads to gelation. In the gel, the solvent media used to dissolve the reactants fills the gel pores, resulting in a wet-gel. By exchanging this solvent for a gas, a highly porous three-dimension network is obtained. As a result, aerogels have very low densities and consequently, they are considered light-weight materials.

Two general drying processes to obtain aerogels can be found in the literature—supercritical and subcritical drying. In the supercritical drying, a fluid is brought above its critical point having no liquid/vapour interface at the pores anymore, and therefore, the capillary forces exerted on the pores are reduced, avoiding the structure collapse. Subcritical drying processes include lyophilization (also called freeze drying), vacuum and/or temperature cycles, chemical modification of the internal surface of the wet-gel pores or ambient evaporation. Traditionally, materials prepared through ambient evaporation are called xerogels, to differentiate them from aerogels, which are prepared in supercritical conditions and from cryogels, which are obtained through lyophilization.

Most known aerogels are inorganic aerogels, mainly based on silica, although different organic aerogels have also been described in the literature.

Inorganic silica aerogels provide high thermal insulating properties; however, they are fragile and have poor mechanical properties. These low mechanical properties are generally attributed to the well-defined narrow interparticle necks. The fragility of silica could be solved by different methods, by crosslinking aerogels with organic polymers or by post-gelation casting of a thin conformal polymer coating over the entire internal porous surface of the preformed wet-gel nanostructure.

Inorganic silica aerogels represent the most traditional type and offer the best thermal insulating performance. However, these materials are brittle, dusty and easy air-borne, and therefore, cannot withstand mechanical stress. Because of that, sometimes they are classified as hazardous materials. In addition, due to their brittleness, they are not suitable for some applications where mechanical properties are required.

First organic aerogels described in the literature were based on phenol-formaldehyde resins. Generally, organic aerogels are not fragile materials. They are based on polymeric networks of different nature, formed by the cross-linking of monomers in solution to yield a gel that is subsequently dried to obtain a porous material. Considerable number of organic aerogels are based on materials prepared using multifunctional isocyanates. Various isocyanate monomers can be used to prepare polyimide aerogels (by reaction with anhydrides), polyamide aerogels (by reaction with carboxylic acids), polyurethane aerogels (by reaction with hydroxylated compounds), polycarbodiimide aerogels or polyurea aerogels (by reaction with aminated compounds or with water as catalyst).

Polyurethane aerogels can be obtained by reacting of cyclic ether based resins with polyisocyanates and subsequently dried by supercritical drying. These aerogels show low thermal conductivity and good mechanical properties. However, these materials are not usually hydrophobic.

Thiourethane has been widely used in the fabrication of elastomers. The thiourethane networks have been used as bridging groups in polysilsesquioxane (PSQ) aerogels (hybrid aerogels).

Both inorganic and organic aerogels are generally hydrophilic. To improve hydrophobicity of an aerogel, the surface of the aerogel can be hydrophobized by using a modification solution wherein surface groups can be replaced by hydrophobic groups, typically, trimethylsilyl (TMS). The TMS groups are most often introduced through trimethylchlorosilane (TMCS), hexamethyldisilazane (HMDZ), or hexamethyldisiloxane (HMDSO) hydrophobization agents. An alternative, and more direct route to obtain open-porous, hydrophobic materials is to use precursors that contain chemically bound hydrophobic groups, for example, methyltri(m)ethoxysilane (MTMS/MTES) or dimethyldimethoxysilane (DMDMS). Furthermore, crosslinking is another method used to improve water resistance of an aerogel by the substitution of hydrophilic groups and the formation of three-dimensional network. However, the addition of cross-linker increases the production cost. Surface coating by formation of rigid and hydrophobic layers on the surfaces of aerogels can also be used to improve both the compressive strength and water resistance of aerogels. However, all these approaches are disadvantageous because of an additional step in the material preparation process after the gel formation.

Therefore, there is a need for an organic aerogel having improved hydrophobicity, while maintaining good mechanical properties and being safe to use and not dusty.

### SUMMARY OF THE INVENTION

The present invention relates to an organic aerogel obtained by reacting an isocyanate compound having a functionality equal to or greater than 2 and a thiol compound having a functionality equal to or greater than 2 in the presence of a solvent.

The present invention also relates to a method for preparing an organic aerogel according to the present invention comprising the steps of: 1) dissolving a thiol compound into a solvent and adding an isocyanate compound and mixing, 2) adding a catalyst if present, and mixing; 3) letting the mixture to stand in order to form a gel; 4) washing said gel with a solvent; 5) drying said gel by (a) supercritical drying or (b) ambient drying, wherein optionally the CO₂ from the supercritical drying is recycled.

The present invention encompasses a thermal insulating material or an acoustic material comprising an organic aerogel according to the present invention.

The present invention also encompasses use of an organic aerogel according to the present invention as a thermal insulating material or acoustic material.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in the disclosing invention, including technical and scientific terms, have the meaning as commonly understood by one of the ordinary skill in the art to which this invention belongs to. By means of further guidance, term definitions are included to better appreciate the teaching of the present invention.

The present invention relates to thiourethane based aerogels obtained by reacting an isocyanate compound having a functionality equal to or greater than 2 and a thiol compound having a functionality equal to or greater than 2 in the presence of a solvent.

The reaction between an isocyanate compound and a thiol compound in a solvent result in a network based on polythiourethanes. General reaction is illustrated in scheme 1 below. The resulting nonporous network may also include small amount of polythiocyanurate as a minor side product of the reaction.

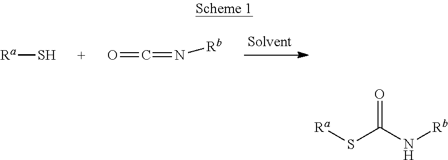

Aerogels according to the present invention are generally hydrophobic, high performance materials. They are light weight and elastic, they have low thermal conductivity, low shrinkage and high mechanical properties. Due the high hydrophobicity, the aerogels according to the present invention have high stability against water and moisture.

Thiourethane based aerogels according to the present invention are obtained by reacting an isocyanate compound having a functionality equal to or greater than 2. Preferably, by reacting an isocyanate compound having a functionality from 2 to 6, and more preferably from 2 to 3.

Isocyanates having functionality from 2 to 3 are preferred, because these isocyanates provide ideal compromise in terms of thermal conductivity and mechanical performance. Furthermore, isocyanates with higher functionality may lead to too fast gelation.

Suitable isocyanate compound for use in the present invention is an aromatic isocyanate compound or an aliphatic isocyanate compound, preferably selected from the group consisting of

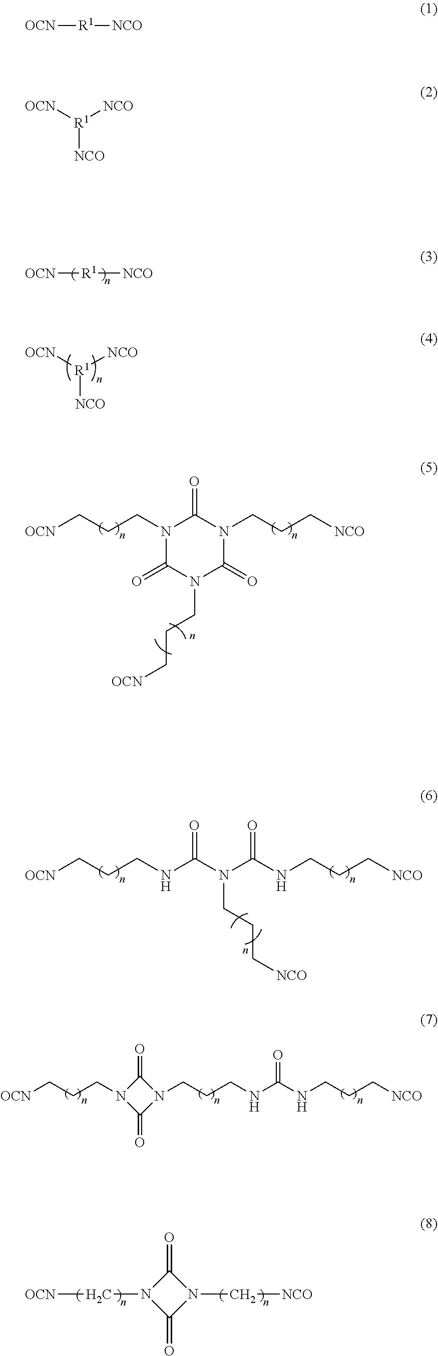

wherein R¹ is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and an integer n is integer from 1 to 30;

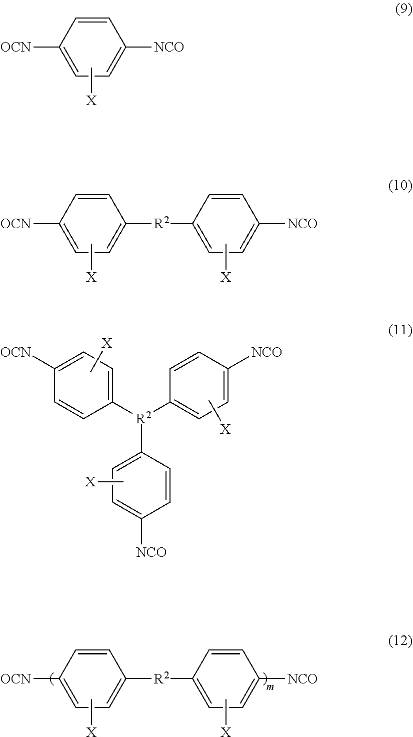

wherein X is same or different substituent and are independently selected from the group consisting of hydrogen, halogen and linear or branched C1-C6 alkyl groups, attached on their respective phenyl ring at the 2-position, 3-position or 4-position, and their respective isomers, and R² is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and an integer m is an integer from 1 to 30;

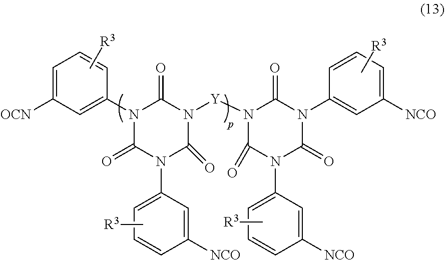

wherein R³ is selected independently from the group consisting of alkyl, hydrogen and alkenyl, and Y is selected from the group consisting of

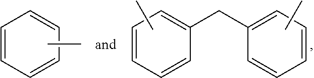

and p is an integer from 0 to 3;

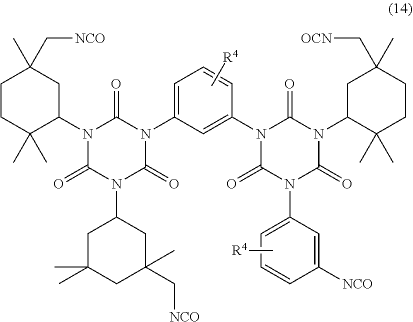

wherein R⁴ is selected independently from the group consisting of alkyl, hydrogen and alkenyl;

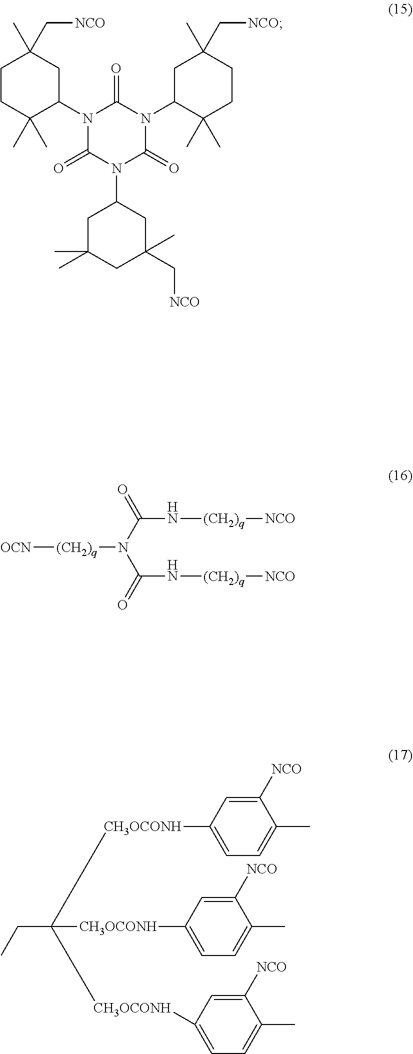

wherein q is an integer from 1 to 6.

More preferably isocyanate compound is selected from the group consisting of 1,1′-methylenebis(4-isocyanatobenzene) (MDI); triphenylmethane-4,4′,4″-triisocyanate; 1,3,5-tris(6-isocyanatohexyl)-1,3,5-triazin-2,4,6-trione; N, N, N′-tris(6-isocyanatohexyl) dicarbonimidic diamide; 5-{5-[3,5-bis(3-isocyanatotolyl)-2,4,6-trioxo-1,3,5-triazinan-1-yl]toly}-1-[3-(3-{3-[3,5-bis(3-isocyanatotolyl)-2,4,6-trioxo-1,3,5-triazinan-1-yl]tolyl}-5-(3-isocyanatotolyl)-2,4,6-trioxo-1,3,5-triazinan-1-yl)tolyl]-3-(3-isocyanatotolyl)-1,3,5-triazinane-2,4,6-trione; 1-[3,5-bis(isocyanatomethyl)-3,5-dimethylcyclohexyl]-3-[3-(isocyanatomethyl)-3,5,5-trimethylcyclohexyl]-5-(4-{3-[3-(isocyanatomethyl)-3,5,5-trimethylcyclohexyl]-5-(3-isocyanatotolyl)-2,4,6-trioxo-1,3,5-triazinan-1-yl}tolyl)-1,3,5-triazinane-2,4,6-trione; di-3-isocyanatotoluidino-3-ethyl-3-[(3-isocyanatotoluidinooxycarbonyl)methyl]glutarate and mixtures thereof.

Above listed isocyanates are preferred, because they provide good gelation conditions (gelation is occurring in at least few seconds) leading to a homogenous aerogel, while more reactive isocyanates would lead to too fast gelation, and subsequently to an inhomogeneous material.

Suitable commercially available isocyanate compounds for use in the present invention include, but are not limited to methylene diphenyl diisocyanate (MDI) from Merck, Polurene KC and Polurene HR from Sapici, and Desmodur N3300, Desmodur N3200, Desmodur 44V, Desmodur 3900, Desmodur 3600, Desmodur I, Desmodur RE and Desmodur L75 from Covestro.

Preferably, the isocyanate compound is present in the reaction mixture from 0.3 to 40% by weight of the total weight of the reaction mixture (including solvent), more preferably from 0.4 to 35%, and even more preferably from 0.5 to 20%.

It is difficult to obtain a gel if the quantity of the isocyanate compound is lower than 0.3%. On the other hand, greater quantity than 40% leaves unreacted monomers in the gel, which will negatively affect to the physical properties of the gel.

Thiourethane based aerogels according to the present invention are obtained by reacting a thiol compound having a functionality equal to or greater than 2. Preferably, by reacting a thiol compound having a functionality from 2 to 6, and more preferably from 2 to 4.

Suitable thiol compound for use in the present invention is selected from the group consisting of

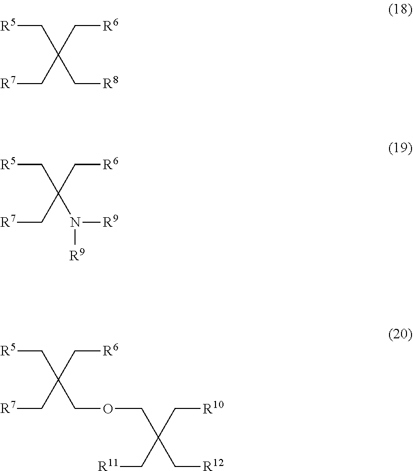

wherein R⁵, R⁶, R⁷, R⁸, R¹⁰, R¹¹, R¹² are same or different and independently selected from O—CO—(CH₂)ᵣ—SH, —O—CO—(CH₂)ᵣ—CHSHCH₃, —(CH₂)ᵣCH₃ or a combination thereof; R⁹ is —(CH₂)ᵣ—R⁵; and wherein r is an integer from 1 to 6;

R¹³—(CH₂)ₛ—R¹⁴ (21)

wherein R¹³ and R¹⁴ are same or different and independently selected from —O—CO—(CH₂)ₜ—SH, —O—CO—(CH₂)ₜ—CH(SH)CH₃, a combination thereof, and wherein t is an integer from 1 to 6 and s is an integer from 1 to 10;

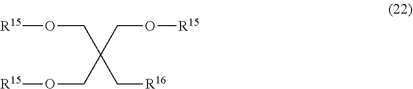

wherein R¹⁵ is —[(CH₂)ᵤO]ₓ—CO—(CH₂)ᵤSH; and wherein R¹⁶ is —(CH₂)ᵤCH₃; and wherein u is an integer from 1 to 6 and x is an integer from 1 to 4;

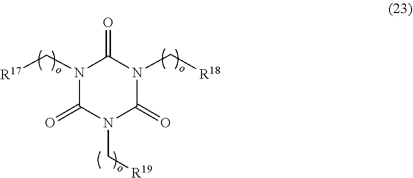

wherein R¹⁷, R¹⁸, R¹⁹ can be same or different and independently selected from —O—CO—(CH₂)_{z}—SH, —O—CO—(CH₂)_{z}—CH(SH)CH₃; wherein o is an integer from 1 to 6 and z is an integer from 1 to 6;

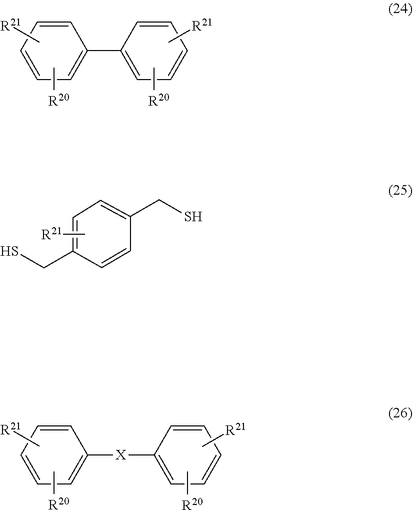

R²⁰ is —(CH₂)_{w}SH and wherein w is an integer from 1 to 6; R²¹ can be same or different substituent and are independently selected from the group consisting of hydrogen, halogen and linear or branched C1-C6 alkyl groups, attached on their respective phenyl ring at the 2-position, 3-position or 4-position, and their respective isomers; and wherein X is selected from the group consisting of a single bonded —O—, —C(O)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof.

Preferably, thiol compound is selected from the group consisting of di pentaerythritol hexakis(3-mercaptopropionate); 4,4′-bis(mercaptomethyl)biphenyl; 1,3,5-tris(3-melcaptobutyloxethyl)-1,3,5-triazine-2,4,6(1H,3H,5H)-trione; pentaerythritol tetrakis (3-mercaptobutylate); trimethylolpropane tris(3-mercaptobutyrate); pentaerythritol tetrakis (3-mercaptobutylate); 1,4-bis(3-rnercaptobutyryloxy)butane and mixtures thereof.

Preferred thiols optimise the performance of the aerogels according to the present invention.

Suitable commercially available thiol compounds for use in the present invention include, but are not limited to dipentaerythritol hexakis(3-mercaptopropionate) (DPMP) from SC Organic Chemical Co., KarenzMT NR1, KarenzMT BD1, KarenzMT TPMB and KarenzMT PE1 and 4,4′-bis(mercaptomethyl)biphenyl (BDT) from Showa Denko; Thiocure PETMP, Thiocure TMPMP, Thiocure Tempic, Thiocure ETTMP 700 and Thiocure GDMP from Bruno Bock.

Preferably, the thiol compound is present in the reaction mixture from 0.2 to 35% by weight of the total weight of the reaction mixture (including solvent), more preferably from 0.4 to 25%, more preferably from 0.4 to 20%.

It is difficult to obtain a gel if the quantity of the thiol compound is lower than 0.3%. On the other hand, greater quantity than 40% leaves unreacted monomers in the gel, which will negatively affect to the physical properties of the gel.

In a preferred embodiment, the organic aerogel according to the present invention have the ratio of thiol groups to isocyanate groups is from 10:1 to 1:10, preferably from 4:1 to 1:4.

If the ratio (isocyanate groups to thiol groups) is higher than 10:1 the reaction mixture will have too much free isocyanate, which later reacts with water and leads non-homogeneous gel. In case the ratio (thiol groups to isocyanate groups) is higher than 10:1 it is difficult to obtain gels and the reaction takes a long time to gel.

In highly preferred embodiment ratio (isocyanate groups to thiol groups) of 1:1 is used and ideal performance aerogels are obtained.

In one embodiment ratios (isocyanate groups to thiol groups) of 2:1 and 1:2 are used and very good performance aerogels are obtained.

In another embodiment ratios (isocyanate groups to thiol groups) of 3:1 and 1:3 are used and very good performance aerogels are obtained.

In another embodiment ratios (isocyanate groups to thiol groups) of 4:1 and 1:4 are used and very good performance aerogels are obtained.

An organic aerogel according to the present invention is obtained by reacting an isocyanate compound having a functionality equal to or greater than 2 and a thiol compound having a functionality equal to or greater than 2 in the presence of a solvent.

Suitable solvent for use in the present invention is a polar solvent, preferably polar aprotic solvent.

The solvent used in the present invention can be selected from the group consisting of dimethyl sulfoxide (DMSO), acetone, 2-butanone (MEK), methyl-isobutyl ketone (MIBK) dimethylacetamide (DMAc), dimethylformamide (DMF), 1-methyl-2-pyrrolidinone (NMP), acetonitrile, chloroform and mixtures thereof.

Suitable commercially available solvents for use in the present invention include but are not limited to dimethyl sulfoxide (DMSO), methyl-isobutyl ketone (MIBK), 2-butanone (MEK) from Merck and acetone from VWR Chemicals.

According to the present invention, solvent is used from 60 to 96% by weight by the total weight of the reaction mixture (including solvent).

If the reaction mixture is too dilute, the gel formation will not occur, and some precipitation may happen. On the other hand, if the reaction mixture is too concentrated, the initial monomers will not dissolve completely, and obtained gel will contain unreacted monomers.

In one embodiment, an organic aerogel according to the present invention can be obtained by reacting an isocyanate compound having a functionality equal to or greater than 2 and a thiol compound having a functionality equal to or greater than 2 in the presence of a catalyst.

The use of a catalyst decreases the gelation time and temperature.

Suitable catalyst for use in the present invention is selected from the group consisting of alkyl amines, aromatic amines, imidazole derivatives, aza compounds, guanidine derivatives, amidines and mixtures thereof.

Preferably catalyst is tertiary amine selected from the group consisting of triazabicyclodecene (TBD), dimethylbenzylamine (DMBA), triethylamine, 1,4-diazabicyclo[2.2.2]octane (DABCO), dibutyltin dilaurate (DBTDL) and mixtures thereof.

Above-mentioned preferred catalysts are preferred because they provide faster gelation and require lower gelation temperature.

Suitable commercially available catalysts for use in the present invention include, but are not limited to triethylamine from Sigma Aldrich; dimethylbenzylamine (DMBA) from Merck and 1,4-diazabicyclo[2.2.2]octane from Alfa Aesar.

Preferably, the catalyst is present in the reaction mixture from 0.1 to 20% by weight of the total weight of the reaction mixture (including solvent), preferably from 0.5 to 10% and more preferably from 1 to 5%.

In one embodiment an organic aerogel according to the present invention may further comprise a reinforcement. Reinforcement is used to improve mechanical properties of an aerogel.

Suitable reinforcement for use in the present invention may be selected from the group consisting of fibres, particles, non-woven and woven fibre fabrics, chopped strand mats, honeycombs, 3D structures and mixtures thereof.

Preferably, the reinforcement is present from 0.1 to 80% by weight of the total weight of the aerogel, preferably from 0.5 to 75%.

If the quantity of the reinforcement is low the properties of the final aerogel will not be improved, whereas quantity more than 80% leads to a high increase of the thermal conductivity of the aerogel.

Suitable commercially available reinforcements for use in the present invention include, but are not limited to honeycomb based on aramid fibre and phenolic resin from Euro composites, an organically-modified clay Tixogel VZ from BYK, glass wool and α-cellulose from Sigma Aldrich, microcrystalline cellulose from Acros Organics, carbon black from Evonik, carbon fibres from Procotex, glass microfibres from Unifrax, glass fibre chopped strand mats from Easycomposites, and polypropylene core from Cel Components.

An organic aerogel according to the present invention has a solid content from 4 to 40%, based on initial weight of the solution, preferably from 4 to 20%.

If the solid content is below 4%, the gelation is very slow and obtained gel is very weak. On the other hand, when the solid content is more than 40% the material has very high density. High density typically leads to high thermal conductivity, which is not desired property.

An organic aerogel according to the present invention has a thermal conductivity less than 60 mW/m·K, preferably less than 50 mW/m·K, more preferably less than 45 mW/m·K, and even more preferably less than 40 mW/m·K.

### Diffusivity Sensor Method

In this method, the thermal conductivity is measured by using a diffusivity sensor. In this method, the heat source and the measuring sensor are on the same side of the device. The sensors measure the heat that diffuses from the sensor throughout the materials. This method is appropriate for lab scale tests.

### Steady-State Condition System Method

In this method the thermal conductivity is measured by using a steady-state condition system. In this method, the sample is sandwiched between a heat source and a heat sink. The temperature is risen on one side, the heat flows through the material and once the temperature on the other side is constant, both heat flux and difference of temperatures are known, and thermal conductivity can be measured.

An organic aerogel according to the present invention has a compression Young's modulus more than 0.1 MPa, preferably more than 15 MPa, and more preferably more than 30 MPa, wherein Compression Young Modulus is measured according to the method ASTM D1621.

An organic aerogel according to the present invention has preferably a compressive strength more than 0.01 MPa, more preferably more than 0.45 MPa, and even more preferably more than 1 MPa. Compressive strength is measured according to the standard ASTM D1621.

An organic aerogel according to the present invention has preferably a specific surface area ranging from 5 m²/g to 300 m²/g. Surface area is determined from N2 sorption analysis at −196° C. using the Brunauer-Emmett-Teller (BET) method, in a specific surface analyser Quantachrome-6B.

High surface area values are preferred because they are indicative of small pore sizes, and which may be an indication of low thermal conductivity values.

An organic aerogel according to the present invention has preferably an average pore size ranging from 5 to 120 nm. Pore size distribution is calculated from Barret-Joyner-Halenda (BJH) model applied to the desorption branch from the isotherms measured by N₂ sorption analysis. Average pore size was determined by applying the following equation: Average pore size=(4*V/SA) wherein V is total pore volume and SA is surface area calculated from BJH. Porosity of the samples can also be evaluated by He pycnometry.

An aerogel pore size below the mean free path of an air molecule (which is 70 nm) is preferred, because that allows obtaining high performance thermal insulation aerogels having very low thermal conductivity values.

An organic aerogel according to the present invention has low-density structure having a bulk density ranging from 0.01 to 0.6 g/cc. Bulk density is calculated from the weight of the dry aerogel and its volume.

An organic aerogel according to the present invention is resistant to low temperatures exposure (from −160° C. to 0° C.). Additionally, an organic aerogel may resist liquid nitrogen immersion (−196° C.) and subsequent evaporation.

For the preparation of organic aerogels according to the present invention, several aspects must be taken into consideration. The stoichiometric ratio of functionalities, the initial solid content, the amount and type of catalyst (if present), type of solvent, gelation time and temperature are crucial factors that affect to the final properties of the material.

In one embodiment, an organic aerogel according to the present invention is prepared according to a method comprising the steps of:

1) dissolving a thiol compound into a solvent and adding an isocyanate compound and mixing,

2) adding a catalyst if present, and mixing;

3) letting the mixture to stand in order to form a gel;

4) washing said gel with a solvent;

5) drying said gel by (a) supercritical drying or (b) ambient drying, wherein optionally the CO₂ from the supercritical drying is recycled.

Thiourethane based aerogels according to the present invention are formed via fast gelation, this is due very fast isocyanate/thiol chemistry.

Preferably, an aerogel according to the present invention is prepared in a closed container.

Gelation step (3) is carried out in the oven for the pre-set time and temperature. Preferably, a temperature from 20 to 100° C. is applied while gel is forming, and more preferably temperature from 25 to 45° C. is applied.

Temperatures from 20 to 100° C. are preferred because of higher temperatures than 100° C. require the use of solvents with extremely high boiling points.

Gelation time is preferably from one minute to 72 hours, preferably from 1 minute to 24 hours, and more preferably from one minute to 60 minutes.

Washing time in step (4) is preferably from 18 hours to 96 hours, preferably from 24 hours to 48 hours.

The solvent of wet gels of step (3) is changed one or more times after the gelation. The washing steps are done gradually, and if required, to the preferred solvent for the drying process. Once the wet gel remains in the proper solvent, it is dried in supercritical (CO₂) or ambient conditions obtaining the final aerogel material.

In one embodiment, the washing steps are done gradually as follows: 1) methyl-isobutyl ketone (MIBK)/acetone 3:1; 2) MIBK/acetone 1:1; 3) MIBK/acetone 1:3; and 4) acetone.

In another embodiment all four washing steps are done with acetone or hexane.

Once the solvent has been completely replaced by acetone, formed gel is dried in supercritical (CO₂) or ambient conditions obtaining the final aerogel material.

The supercritical state of a substance is reached once its liquid and gaseous phases become indistinguishable. The pressure and temperature at which the substance enters this phase is called critical point. In this phase, the fluid presents the low viscosity of a gas, maintaining the higher density of a liquid. It can effuse through solids like a gas and dissolve materials like a liquid. Considering an aerogel, once the liquid inside the wet gel pores reaches the supercritical phase, its molecules do not possess enough intermolecular forces to create the necessary surface tension that creates capillarity stress. Hence, the solvent can be dried, minimizing shrinkage and possible collapse of the gel network.

The drying process at supercritical conditions is performed by exchanging the solvent in the gel with CO₂ or other suitable solvents in their supercritical state. Due to this, capillary forces exerted by the solvent during evaporation in the nanometric pores are minimized and shrinkage of the gel body can be reduced.

In one embodiment, the method for preparing the organic aerogel involves the recycling of the CO₂ from the supercritical drying step.

Alternatively, wet gels can be dried at ambient conditions, in which the solvent is evaporated at room temperature. However, as the liquid evaporates from the pores, it can create a meniscus that recedes back into the gel due to the difference between interfacial energies. This may create a capillary stress on the gel, which responds by shrinking. If these forces are higher enough, they can even lead to the collapse or cracking of the whole structure. However, there are different possibilities to minimize this phenomenon. One practical solution involves the use of solvents with low surface tension to minimize the interfacial energy between the liquid and the pore. Unfortunately, not all the solvents lead to gelation, which means that some cases would require the exchange of solvent between an initial one required for the gel formation and a second one most appropriate for the drying process. Hexane is usually used as a convenient solvent for ambient drying, as its surface tension is one of the lowest among the conventional solvents.

The present invention compasses a thermal insulating material or an acoustic material comprising an organic aerogel according to the present invention.

An organic aerogel according to the present invention can be used as a thermal insulating material or acoustic material.

Organic aerogels according to the present invention may be used in a variety of applications such as building construction, electronics or for the aerospace industry. An organic aerogel could be used as thermal insulating material for refrigerators, freezers, automotive engines and electronic devices. Other potential applications for aerogels is as a sound absorption material and a catalyst support.

Organic aerogels according to the present invention can be used for thermal insulation in different applications such as aircrafts, space crafts, pipelines, tankers and maritime ships replacing currently used foam panels and other foam products, in car battery housings and under hood liners, lamps, in cold packaging technology including tanks and boxes, jackets and footwear and tents.

Organic aerogels according to the present invention can also be used in construction materials due to their lightweight, strength, ability to be formed into desired shapes and superior thermal insulation properties.

In highly preferred embodiment an organic aerogel according to the present invention can be used as a thermal insulating material for the storage of cryogens.

Organic aerogels according to the present invention can be also used as an adsorption agent for oil spill clean-up, due to their high oil absorption rate.

Organic aerogels according to the present invention can be also used in safety and protective equipment as a shock-absorbing medium.

### EXAMPLES

In all following examples thermal conductivity was measured with the C-Therm TCi, and mechanical properties were determined according to ASTM D1621. Density was determined as the mass of aerogel divided by the geometrical volume of aerogel.

$$Density = \frac{aerogel mass}{aerogel volume}$$

Linear shrinkage was determined as the difference between the gel and aerogel diameters divided by the gel diameter and multiplied by 100.

$$Linear shinkage ( \% ) = ( \frac{Gel diameter - Aerogel diameter}{Gel diameter} ) \cdot 100$$

### Example 1

Thiourethane aerogel was prepared by using aromatic isocyanate (MDI) and hexa-functional primary thiol (dipentaerythritol hexakis(3-mercaptopropionate) (DPMP)) without catalyst. The reaction is illustrated in scheme 2.

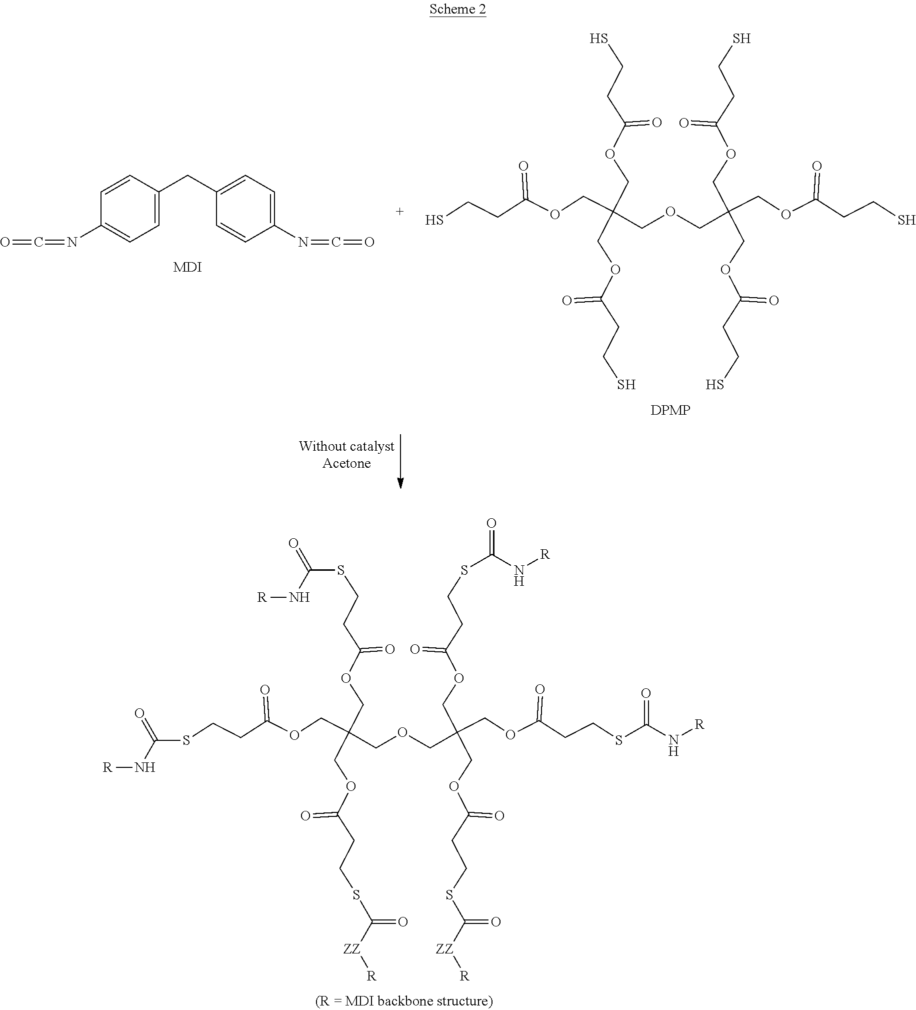

The solution was prepared with 20 wt % of solid content, an equivalent ratio isocyanate/thiol of 1:1, without catalyst and acetone as a solvent.

For the preparation of a sample of 30 mL 2.57 g of DPMP was dissolved in 15.1 g of acetone and subsequently 2.46 g of MDI was added. The mixture was stirred manually and left at 45° C. for 48 h. The resulting gel was washed three times with acetone every 24 h and using a volume of solvent three times the volume of the gel for each step. Subsequently the gel was dried via CO₂ supercritical drying (SCD). Table 1 illustrates measured properties of the obtained aerogel.

TABLE 1

| | Linear | Thermal | Compression |
|---|---|---|---|
| Density | shrinkage | conductivity | Modulus |
| (g/cm³) | (%) | (mW/m · K) | (MPa) |
| 0.405 | 25 | 38 | 29.9 |

### Example 2

Thiourethane aerogel was prepared by using aromatic isocyanate (MDI), a three-functional secondary thiol (KarenzMT NR1) and Et₃N as a catalyst. The reaction is illustrated in scheme 3.

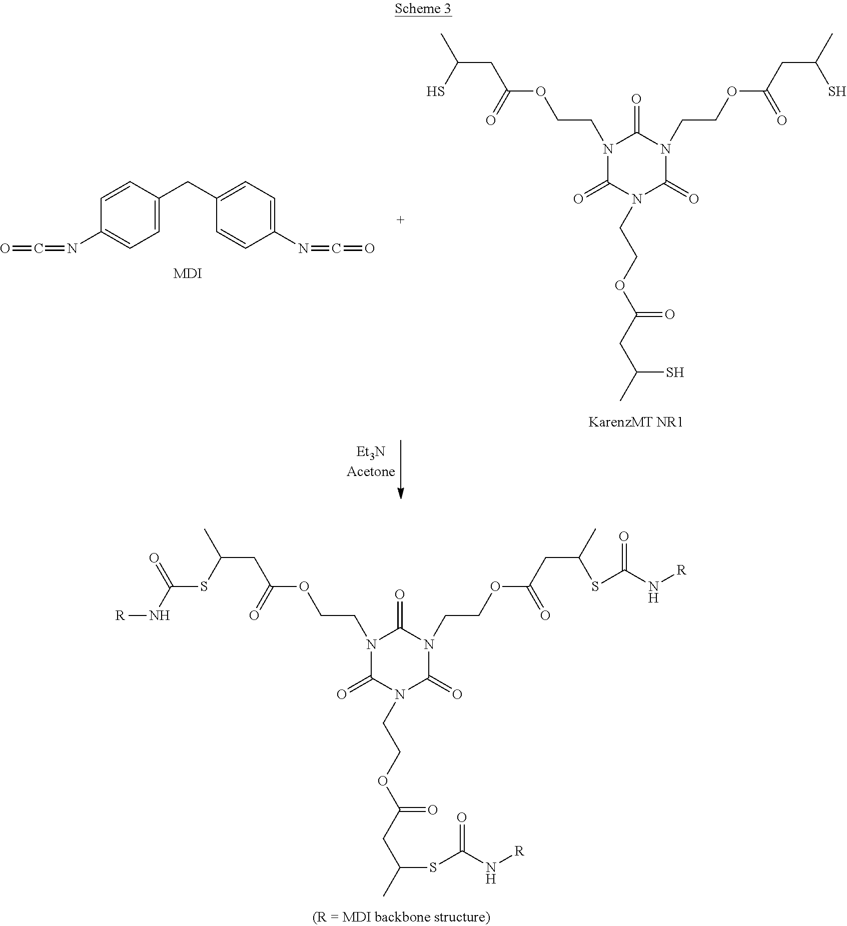

The solution was prepared with 10 wt % of solid content and an equivalent ratio isocyanate/thiol of 1:1, with a 10% of Et₃N as a catalyst and acetone as a solvent.

Aerogels were prepared from two solutions. For the preparation of a sample of 30 mL, a first solution was prepared by dissolving 1.45 g of KarenzMT NR1 in 10 g of acetone and subsequently 0.96 g of MDI was added. A second solution was prepared by dissolving Et₃N (0.240 g) in 11.68 g of acetone. The first and second solutions were mixed, and a gel was obtained in 1 min. The resulting gel was washed three times with acetone every 24 h and using a volume of solvent three times the volume of the gel for each step. Subsequently the gel was dried via CO₂ supercritical drying (SCD). Table 2 illustrates measured properties of the obtained aerogel.

TABLE 2

| | Linear | Thermal | Compression |
|---|---|---|---|
| Density | shrinkage | conductivity | Modulus |
| (g/cm³) | (%) | (mW/m · K) | (MPa) |
| 0.192 | 19 | 38 | 2.60 |

### Example 3

Thiourethane aerogel was prepared by a hexa-functional aromatic isocyanate (Polurene KC), a tri-functional secondary thiol (TPMB), and diazabicyclo[2.2.2]octane (DABCO) as a catalyst. The reaction is illustrated in scheme 4.

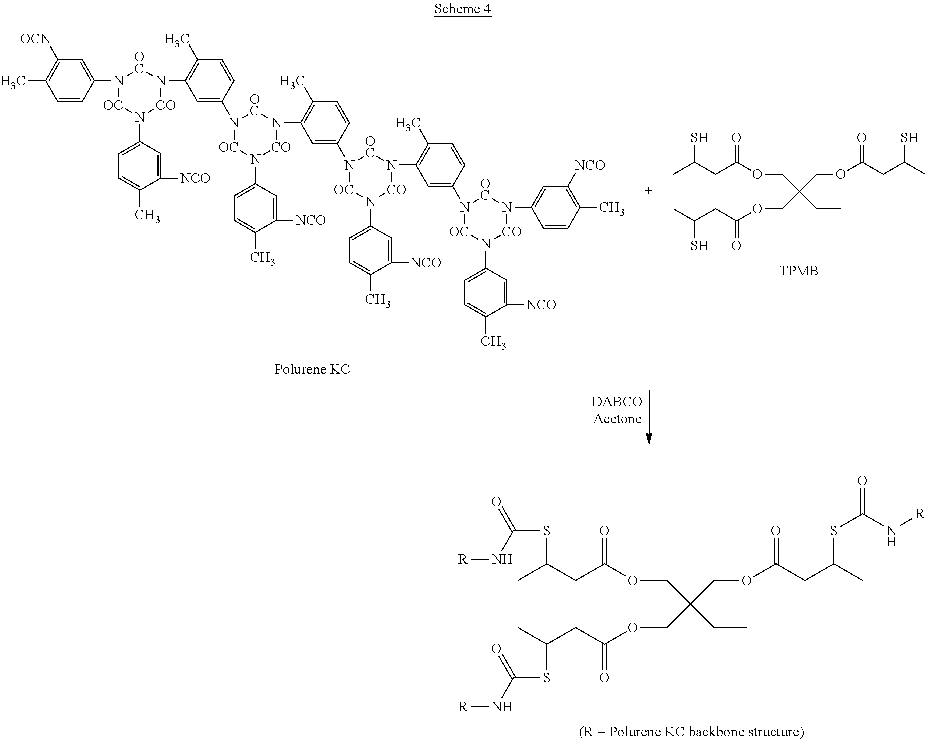

The solution was prepared with 5 wt % of solid content and an equivalent ratio isocyanate/thiol of 1:1, with a 5% of DABCO as a catalyst and acetone as a solvent.

Aerogels were prepared from two solutions. For the preparation of a sample of 30 mL, a first solution was obtained by dissolving 0.43 g of TPMB in 10 g of acetone and subsequently 1.56 g of Polurene KC were added. A second solution was prepared by dissolving DABCO (0.06 g) in 12.7 g of acetone. The first and second solutions were mixed, and gel was obtained in less than 1 min. The resulting gel was washed three times with acetone every 24 h and using a volume of solvent three times the volume of the gel for each step. Subsequently the gel was dried via CO₂ supercritical drying (SCD). Table 3 illustrates measured properties of the obtained aerogel.

TABLE 3

| | Linear | Thermal | Compression |
|---|---|---|---|
| Density | shrinkage | conductivity | Modulus |
| (g/cm³) | (%) | (mW/m · K) | (MPa) |
| 0.118 | 23 | 36.4 | 2.1 |

### Example 4

Thiourethane aerogel was prepared by a tetra-functional aromatic isocyanate (Polurene HR), a tri-functional secondary thiol (TPMB), and DABCO as a catalyst. Reaction is illustrated in scheme 5.

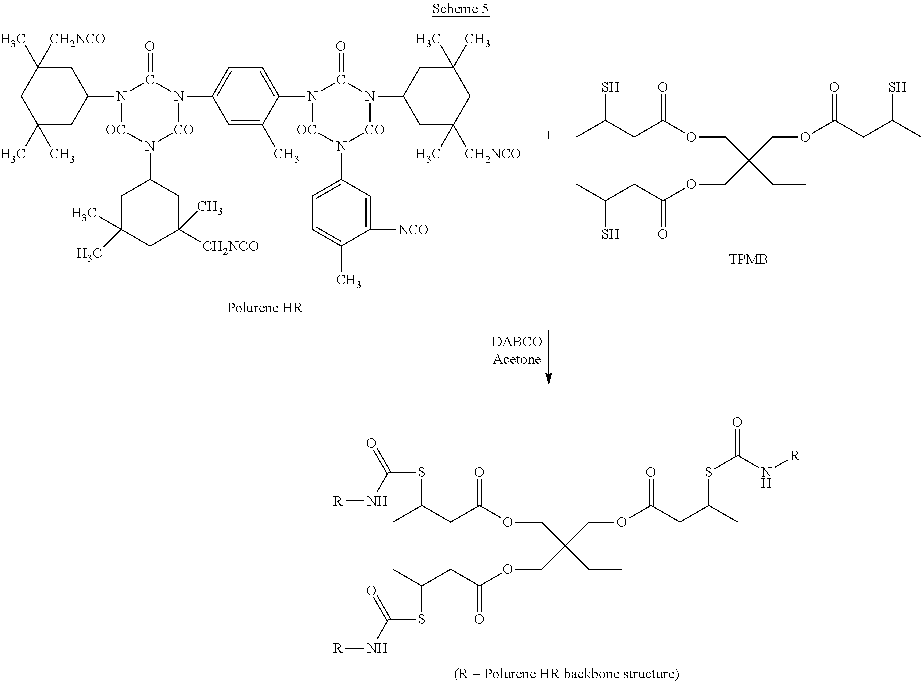

The solution is prepared with a 5 wt % of solid content and an equivalent ratio isocyanate/thiol of 1:1, with a 10% of DABCO as a catalyst and acetone as a solvent.

Aerogels were prepared from two solutions. For the preparation of a sample of 30 mL, a first solution was obtained by dissolving 0.43 g of TPMB in 10 g of acetone and subsequently 1.55 g of Polurene HR was added. A second solution was prepared by dissolving DABCO (0.123 g) in 12.12 g of acetone. First and second solutions were mixed, and gel was obtained in less than 1 min. The resulting gel was washed three times with acetone every 24 h and using a volume of solvent three times the volume of the gel for each step. Subsequently the gel was dried via CO₂ supercritical drying (SCD). Table 4 illustrates measured properties of the obtained aerogel.

TABLE 4

| | Linear | Thermal | Compression |
|---|---|---|---|
| Density | shrinkage | conductivity | Modulus |
| (g/cm³) | (%) | (mW/m · K) | (MPa) |
| 0.095 | 23 | 39.3 | 0.01 |

### Example 5

Thiourethane aerogel was prepared by a three functional aliphatic isocyanate (Desmodur N3300), a tetra-functional secondary thiol (KarenzMT PE1) and Et₃N as a catalyst. The reaction is illustrated in scheme 6.

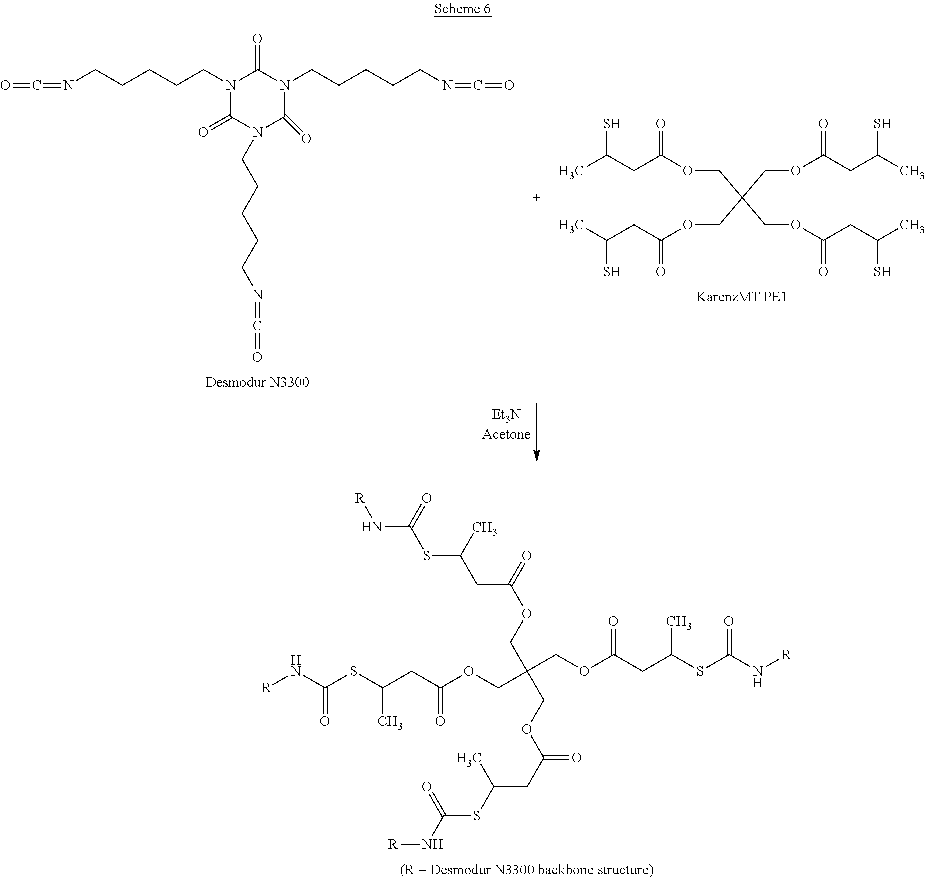

The solution was prepared with a 10 wt % of solid content and an equivalent ratio isocyanate/thiol of 1:1, with a 10% of Et₃N as a catalyst and acetone as a solvent.

For the preparation of a sample of 30 mL a solution was prepared by dissolving 1 g of KarenzMT PE1 in 21.3 g of acetone and subsequently 1.42 g of Desmodur N3300 was added, and finally 0.24 g of a catalyst. The solution gelled in 30 seconds. The resulting gel was washed three times with acetone every 24 h and using a volume of solvent three times the volume of the gel for each step. Subsequently the gel was dried via CO₂ supercritical drying (SCD). Table 5 illustrates measured properties of the obtained aerogel.

TABLE 5

| | Linear | Thermal | Compression |
|---|---|---|---|
| Density | shrinkage | conductivity | Modulus |
| (g/cm³) | (%) | (mW/m · K) | (MPa) |
| 0.434 | 45.4 | 52.2 | 31.1 |

### Example 6

Thiourethane aerogel was prepared by a three-functional aliphatic isocyanate (Desmodur N3200), a di-functional aromatic thiol (4,4′-bis(mercaptomethyl)biphenyl, (BDT)) and DABCO as a catalyst. The reaction is illustrated in scheme 7.

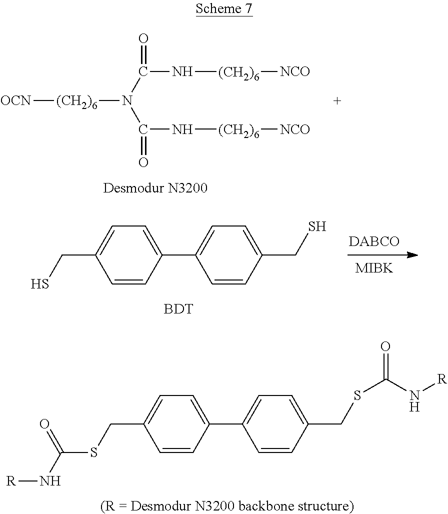

The solution was prepared with 15 wt % of solid content and an equivalent ratio isocyanate/thiol of 1:1, with a 10% of DABCO as a catalyst and MIBK as a solvent.

For the preparation of a sample of 6 mL, a first solution was prepared by dissolving of 0.29 g of BDT in 3.0 g of methylethylketone MIBK and subsequently 0.44 g of Desmodur N3200 was added. A second solution of 0.074 g of DABCO was dissolved in 1.19 g of MIBK. The first and second solutions were mixed, and the final solution was gelled in 10 seconds. The resulting gel was washed stepwise in a mixture of acetone 1:3 MIBK, acetone 1:1 MIBK, acetone 3:1 MIBK and acetone. The duration of each washing step was 24 h and using a volume of solvent three times the volume of the gel for each step. Subsequently the gel was dried via CO₂ supercritical drying (SCD). Table 6 illustrates measured properties of the obtained aerogel.

TABLE 6

| | Linear | Thermal | Compression |
|---|---|---|---|
| Density | shrinkage | conductivity | Modulus |
| (g/cm³) | (%) | (mW/m · K) | (MPa) |
| 0.126 | 7.41 | 43.6 | 0.19 |

### Example 7

Thiourethane aerogel was prepared by a three-functional isocyanate (Desmodur L75), a di-functional aromatic thiol (4,4′-bis(mercaptomethyl)biphenyl, (BDT)) and DABCO as a catalyst. The reaction is illustrated in scheme 8.

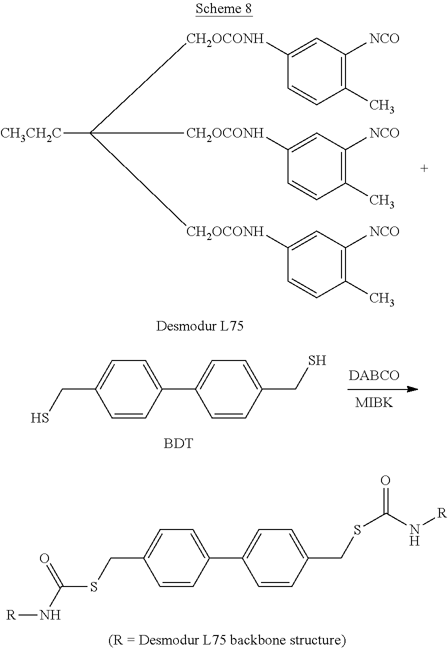

The solution was prepared with 15 wt % of solid content and an equivalent ratio isocyanate/thiol of 2:1, with a 10% of DABCO as a catalyst and MIBK as a solvent.

For the preparation of a sample of 6 mL, a first solution was prepared by dissolving 0.16 g of BDT in 3.0 g of MIBK and subsequently 0.79 g of Desmodur L75 was added. A second solution was prepared by dissolving 0.037 g of DABCO in 1.26 g of MIBK. The first and second solutions were mixed, and the final solution gelled in 10 seconds. The resulting gel was washed stepwise in a mixture of acetone 1:3 MIBK, acetone 1:1 MIBK, acetone 3:1 MIBK and acetone. The duration of each washing step was 24 h and using a volume of solvent three times the volume of the gel for each step. Subsequently the gel was dried via CO₂ supercritical drying (SCD). Table 7 illustrates measured properties of the obtained aerogel.

TABLE 7

| | Linear | Thermal | Compression |
|---|---|---|---|
| Density | shrinkage | conductivity | Modulus |
| (g/cm³) | (%) | (mW/m · K) | (MPa) |
| 0.153 | 7.41 | 43.6 | 0.86 |

### Example 8

Thiourethane Aerogel Reinforced with a Honeycomb Based on Aramid Fibre and Phenolic Resin

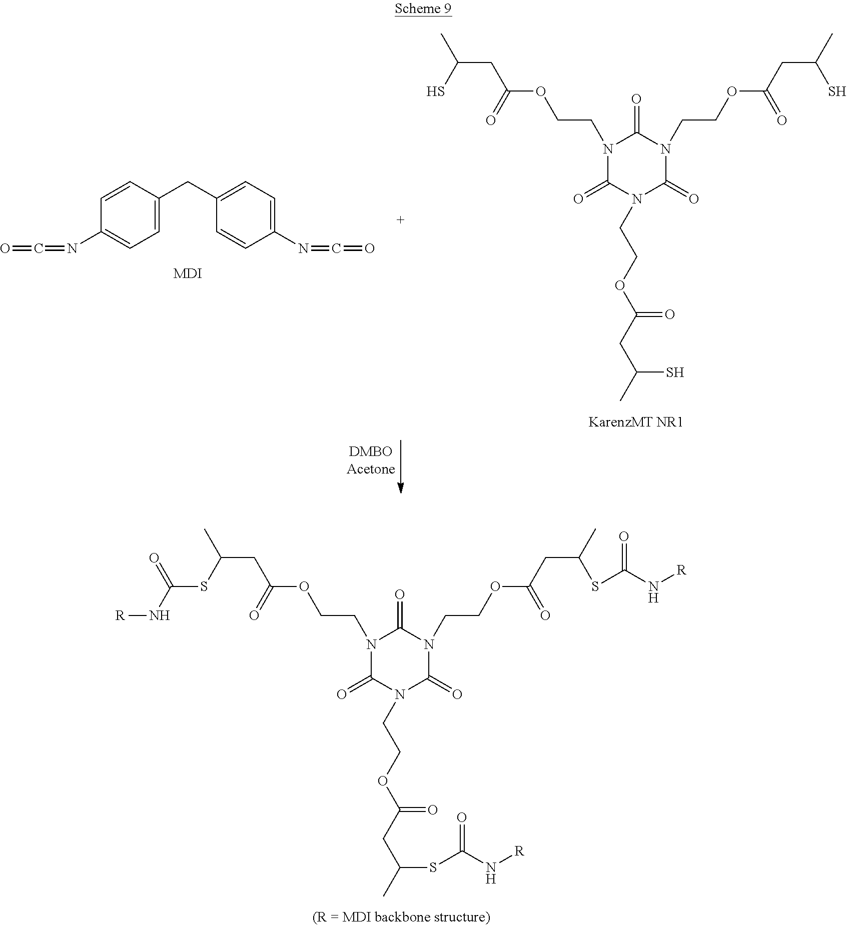

The solution was composed of a three-functional secondary thiol (KarenzMT NR1), a solvent (acetone) and a difunctional aromatic isocyanate (MDI). The solution was prepared with a 10 wt % of solid content and an equivalent ratio isocyanate/thiol of 1:1, with a 10% of DM BA as a catalyst. The honeycomb was based on aramid fibre and phenolic resin, showing a density of 48 kg/m³ and a cell size of 4.8 mm.

For the preparation of a sample of 30 mL, a first solution was prepared by dissolving 1.451 g of KarenzMT NR1 in 15 g of acetone and then 0.957 g of MDI was added. A second solution of 0.242 g of DMBA was dissolved in 6.68 g of acetone. The first and second solutions were mixed and poured into a container with the reinforcement (0.70 g). The final solution was gelled in 1 min. The resulting gel was washed three times with fresh acetone. The duration of each washing step was 24 h and using a volume of solvent three times the volume of the gel for each step. Subsequently the gel was dried via CO₂ supercritical drying (SCD). Table 8 illustrates measured properties of the obtained aerogel.

TABLE 8

| | Linear | Thermal | Compression |
|---|---|---|---|
| Density | shrinkage | conductivity | Modulus |
| (g/cm³) | (%) | (mW/m · K) | (MPa) |
| 0.149 | 5.0 | 40.9 | 68.8 |

### Example 9

Thiourethane Aerogel Reinforced with 2 wt % of Clay Nanoparticles

The solution was composed of a di-functional secondary thiol (KarenzMT BD1), a solvent (acetone), and a difunctional aromatic isocyanate (MDI). The reaction is illustrated in scheme 10.

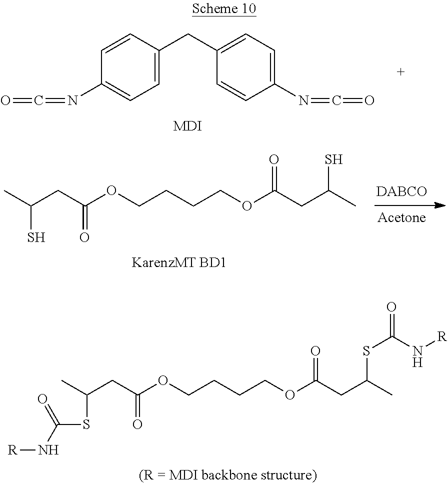

The solution was prepared with a 10 wt % of solid content and an equivalent ratio isocyanate/thiol of 1:1, with a 10% of DABCO as a catalyst. The reinforcement incorporated was an organically-modified clay, Tixogel VZ.

For the preparation of a sample of 30 mL, a first solution was prepared dispersing 0.048 g of clay in 15 g of acetone by using a speed mixer at 3500 rpm for 3 min. Subsequently 1.319 g of KarenzMT BD1 and 1.10 g of MDI were added to the dispersion. A second solution was prepared by dissolving 0.241 g of DABCO in 6.78 g of acetone. The first and second solutions were mixed, and the final solution gelled in less than 10 seconds. The resulting gel was washed three times with fresh acetone. The duration of each step was 24 h and using a volume of solvent three times the volume of the gel for each step. Subsequently the gel was dried via CO₂ supercritical drying (SCD). Table 9 illustrates measured properties of the obtained aerogel.

TABLE 9

| | Linear | Thermal | Compression |
|---|---|---|---|
| Density | shrinkage | conductivity | Modulus |
| (g/cm³) | (%) | (mW/m · K) | (MPa) |
| 0.355 | 43.5 | 53.1 | 29.7 |

### Example 10

Thiourethane aerogel was prepared by using aromatic isocyanate (Desmodur RE), a tetra-functional primary thiol (PETMP) and DABCO as a catalyst. The reaction is illustrated in scheme 11.

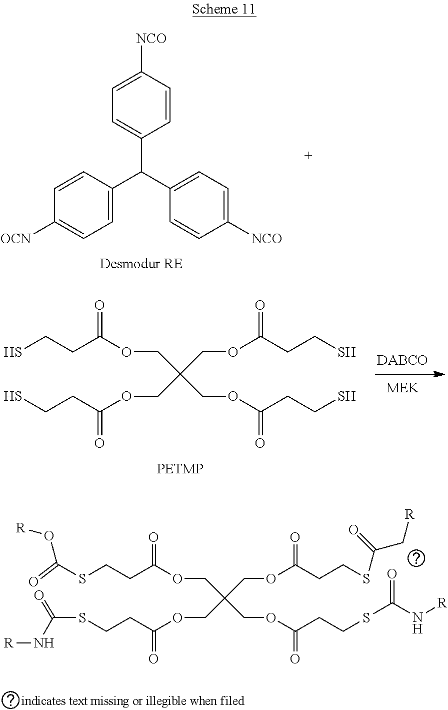

The solution was prepared with 5 wt % of solid content and an equivalent ratio isocyanate/thiol of 1:4, with a 10% of DABCO as a catalyst and MEK as a solvent.

Aerogels were prepared from two solutions. For the preparation of a sample of 30 mL, a first solution was prepared by dissolving 0.98 g of PETMP in 10 g of MEK and subsequently 0.90 g of Desmodur RE was added. A second solution was prepared by dissolving DABCO (0.061 g) in 12.51 g of MEK. The first and second solutions were mixed, and a gel was obtained in 1 week. The resulting gel was washed three times with acetone every 24 h and using a volume of solvent three times the volume of the gel for each step. Subsequently the gel was dried via CO₂ supercritical drying (SCD). Table 10 illustrates measured properties of the obtained aerogel.

TABLE 10

| | Linear | Thermal | Compression |
|---|---|---|---|
| Density | shrinkage | conductivity | Modulus |
| (g/cm³) | (%) | (mW/m · K) | (MPa) |
| 0.070 | 13 | 38 | 0.01 |

What is claimed is:

1. An organic aerogel obtained by reacting an isocyanate compound having a functionality equal to or greater than 2 and a thiol compound having a functionality equal to or greater than 2 in the presence of a solvent.

2. An organic aerogel according to claim 1, wherein said isocyanate compound and said thiol compound are reacted in the presence of a catalyst.

3. An organic aerogel according to claim 1, wherein said isocyanate compound has a functionality from 2 to 6.

4. An organic aerogel according to claim 1, wherein said thiol compound has a functionality from 2 to 6.

5. An organic aerogel according to claim 1, wherein said isocyanate compound is an aromatic isocyanate compound or an aliphatic isocyanate compound selected from the group consisting of 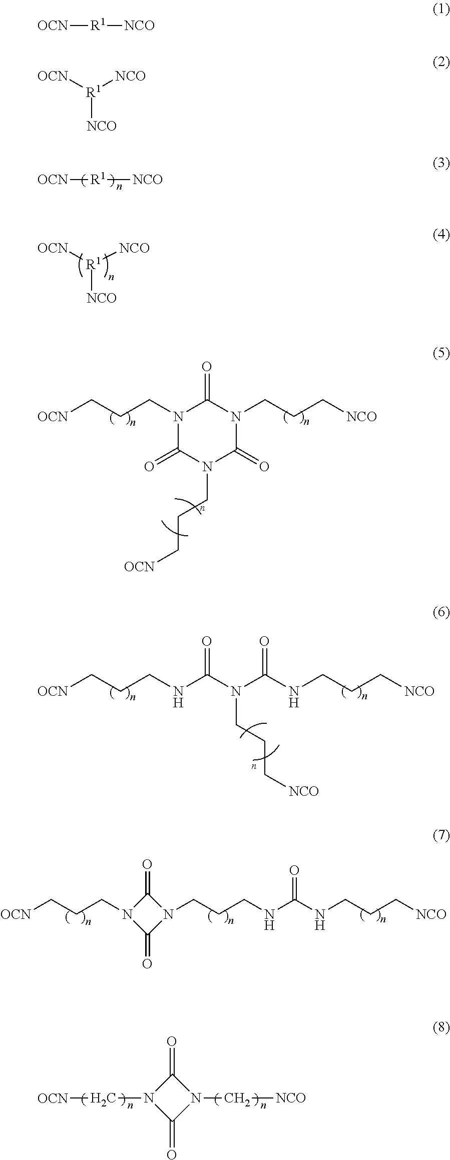
wherein R¹ is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and an integer n is integer from 1 to 30; 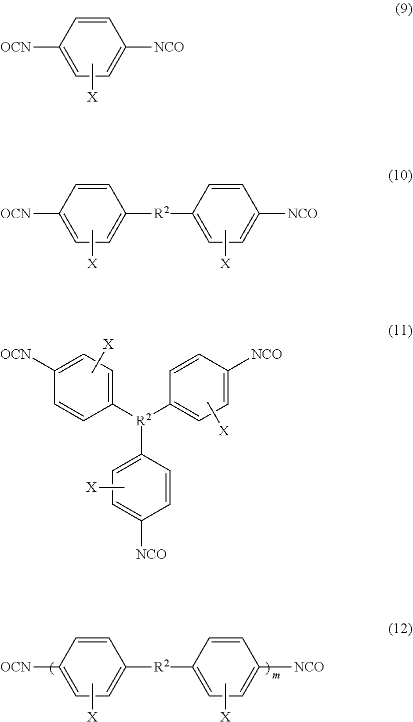
wherein X is same or different substituent and are independently selected from the group consisting of hydrogen, halogen and linear or branched C1-C6 alkyl groups, attached on their respective phenyl ring at the 2-position, 3-position or 4-position, and their respective isomers, and R² is selected from the group consisting of a single bonded —O—, —S—, —C(O)—, —S(O)₂—, —S(PO₃)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof; and an integer m is an integer from 1 to 30; 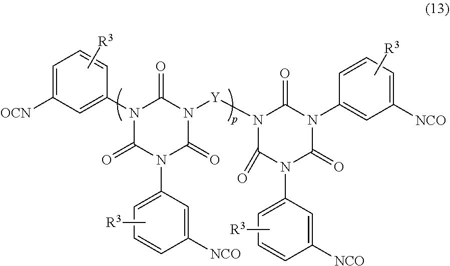
wherein R³ is selected independently from the group consisting of alkyl, hydrogen and alkenyl,
and Y is selected from the group consisting of 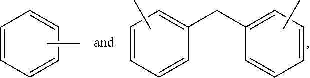
and p is an integer from 0 to 3; 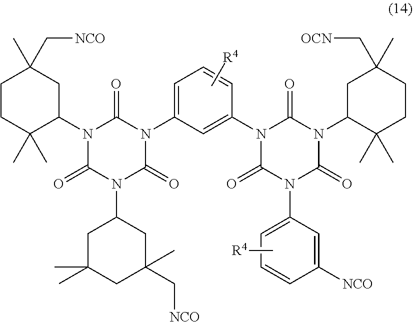
wherein R⁴ is selected independently from the group consisting of alkyl, hydrogen and alkenyl; 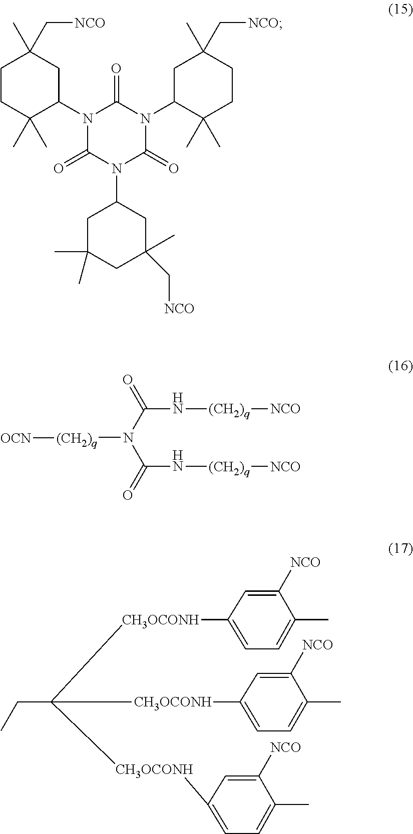
wherein q is an integer from 1 to 6.

6. An organic aerogel according to claim 1, wherein said thiol compound is selected from the group consisting of 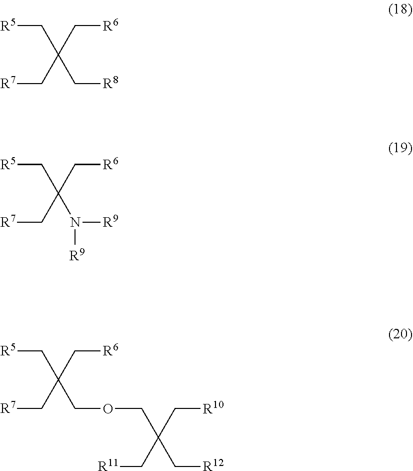
wherein R⁵, R⁶, R⁷, R⁸, R¹⁰, R¹¹, R¹² are same or different and independently selected from —O—CO—(CH₂)ᵣ—SH, —O—CO—(CH₂)ᵣ—CHSHCH₃, —(CH₂)₁CH₃ or a combination thereof; R⁹ is —(CH₂)ᵣ—R⁵; and wherein r is an integer from 1 to 6;
R¹³—(CH₂)ₛ—R¹⁴ (21)
wherein R¹³ and R¹⁴ are same or different and independently selected from —O—CO—(CH₂)ₜ—SH, O—CO—(CH₂)ₜ—CH(SH)CH₃, a combination thereof, and wherein t is an integer from 1 to 6 and s is an integer from 1 to 10; 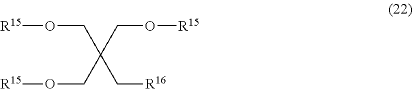
wherein R¹⁵ is —[(CH₂)ᵤO]ₓ—CO—(CH₂)ᵤSH; and wherein R¹⁶ is —(CH₂)_{z}CH₃; and wherein u is an integer from 1 to 6 and x is an integer from 1 to 4; 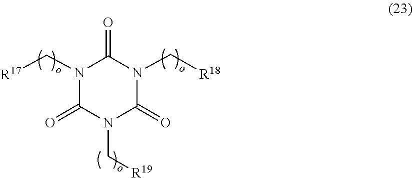
wherein R¹⁷, R¹⁸, R¹⁹ can be same or different and independently selected from —O—CO—(CH₂)_{z}—SH, O—CO—(CH₂)_{z}—CH(SH)CH₃; wherein o is an integer from 1 to 6 and z is an integer from 1 to 6; 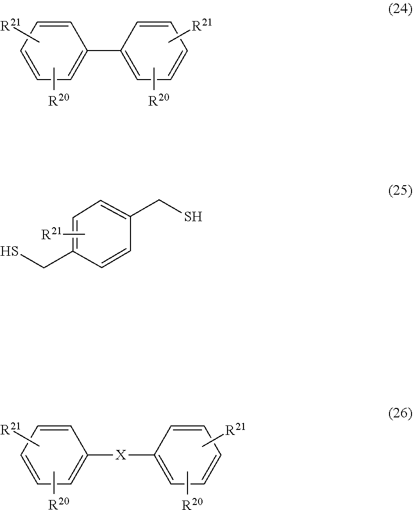
R²⁰ is —(CH₂)_{w}SH and wherein w is an integer from 1 to 6; R²¹ can be same or different substituent and are independently selected from the group consisting of hydrogen, halogen and linear or branched C1-C6 alkyl groups, attached on their respective phenyl ring at the 2-position, 3-position or 4-position, and their respective isomers; and wherein X is selected from the group consisting of a single bonded —O—, —C(O)—, a substituted or unsubstituted C1-C30 alkyl group, a substituted or unsubstituted C3-C30 cycloalkyl group, a substituted or unsubstituted aryl group, a substituted or unsubstituted C7-C30 alkylaryl group, a substituted or unsubstituted C3-C30 heterocycloalkyl group and a substituted or unsubstituted C1-C30 heteroalkyl group and a combination of thereof.

7. An organic aerogel according to claim 1, wherein ratio of thiol groups to isocyanate groups is 10:1-1:10.

8. An organic aerogel according to claim 2, wherein said catalyst is selected from the group consisting of alkyl amines, aromatic amines, imidazole derivatives, aza compounds, guanidine derivatives, amidines and mixtures thereof, preferably catalyst is tertiary amine selected from the group consisting of triazabicyclodecene (TBD), dimethylbenzylamine (DMBA), triethylamine, 1,4-diazabicyclo[2.2.2]octane (DABCO) and mixtures thereof.

9. An organic aerogel according to claim 1, wherein said organic aerogel has a solid content from 4 to 40%, based on initial weight of the solution.

10. An organic aerogel according to claim 1, wherein said organic aerogel has a thermal conductivity less than 60 mW/m·K.

11. An organic aerogel according to claim 1, wherein said aerogel further comprises a reinforcement selected from the group consisting of fibres, particles, non-woven and woven fibre fabrics, chopped strand mats, honeycombs, 3D structures and mixtures thereof.

12. A method for preparing an organic aerogel according to claim 1 comprising the steps of:
1) dissolving a thiol compound into a solvent and adding an isocyanate compound and mixing,
2) adding a catalyst if present, and mixing;
3) letting the mixture to stand in order to form a gel;
4) washing said gel with a solvent;
5) drying said gel by (a) supercritical drying or (b) ambient drying,
wherein optionally the CO₂ from the supercritical drying is recycled.

13. A method according to claim 12, wherein temperature from room temperature to 100° C. is applied at step 3 to form a gel.

14. A thermal insulating material or an acoustic material comprising an organic aerogel according to claim 1.

15. An organic aerogel according to claim 1 as a thermal insulating material or acoustic material.

16. An organic aerogel according to the claim 15 as a thermal insulating for the storage of cryogens.
